(19) United States
(12) Patent Application Publication
(10) Pub. No.: US 2015/0187024 A1
(43) Pub. Date: Jul. 2, 2015

(54) System and Method for Socially Aware Recommendations Based on Implicit User Feedback

(71) Applicant: TELEFONICA DIGITAL ESPAÑA, S.L.U., Madrid (ES)

(72) Inventors: Alexandros KARATZOGLOU, Barecelona (ES); Linas BLATRUNAS, BARECELONA (ES)

(73) Assignee: TELEFONICA DIGITAL ESPAÑA, S.L.U., MADRID (ES)

(21) Appl. No.: 14/142,378

(22) Filed: Dec. 27, 2013

(51) Int. Cl. G06Q 50/00; G06Q 30/02

(52) U.S. Cl. CPC G06Q 50/01; G06Q 30/0201

(57) ABSTRACT

A content recommender based on collaborative filtering and implicit user feedbacks comprising retrieving a social graph split into a user and the user's relationship network in order to obtain a social aware model of the user's preferences based on preferences of the users belonging to the user's relationship network, minimizing the objective function for all the response values of the whole user-item matrix, the response values meaning implicit and explicit feedback data, providing a list of content recommendations obtained by a score function computed using the social aware model.

### FIELD OF THE INVENTION

The current disclosure has its application within the telecommunication sector and, more particularly, relates to a method for Social Aware recommendations of multimedia content to customers/users by Socially enabled Collaborative Filtering.

### BACKGROUND OF THE INVENTION

Nowadays there is a huge amount of multimedia content available and the need for recommendation, personalization and filtering is continuously growing. A recommendation system provides a specific type of filter that tries to show items according to user preferences.

In general terms, there are two basic types of recommendation techniques: content-based filtering and collaborative filtering. Content-based recommendation (CBR) methods examine items previously rated by the user. Collaborative filtering (CF) uses recommendations based on information about similar items or users. CBR relies on resources similarity, while CF relies on users' preferences and behavior.

In the age of information overload, collaborative filtering and recommender systems have become essential tools for content discovery. The advent of online social networks has added another approach to recommendation whereby the social network itself is used as a source for recommendations i.e. users are recommended items that are preferred by their friends.

Combining direct recommendation over the social graph and recommendations using a collaborative filtering method can yield significant advantages both in terms of the quality of the recommendations but also in terms of computational efficiency and speed.

Online social networks (OSN) provide users with new forms of interaction that currently shape the social lives of millions of people. The main ingredient of the success of OSN's is the ease with which friendships, groups and communities arise. These groups often arise among like-minded users, i.e. users that share the same interests. To explain our inexorable tendency to link up with one another in ways that reinforce rather than test our preferences sociologists in the 1950s, coined the term “homophily” a Greek word meaning love of the same. Fundamental to online social networks and their commercial success is the commercial exploitation of this phenomenon. The principle of homophily is used to recommend products and services through the social graph, i.e. if your friends like an item it will be recommended to you. In effect, the social graph is used as the recommendation engine. Leveraging the social graph to serve the user with potentially useful services (e.g. places, videos, coupons, etc.) can improve the satisfaction, the involvement and the time the user spends on the network.

Most recommendation algorithms work by modeling the bipartite graph of user-item preferences. Much of the current work on OSN data and Collaborative Filtering models utilize the social graph data in order to impose additional constrains on the modeling process. In effect, an implicit social network among users who share the same taste is built and exploited.

For example, in “Learning to recommend with social trust ensemble” by Ma et al., Proceedings of the 32nd International ACM SIGIR Conference on Research and Development in Information Retrieval, SIGIR 2009, pp. 203-210. ACM, New York, 2009, a trust ensemble model is introduced, wherein the user is modeled as an ensemble of his own and his friends preferences. This method only deals with explicit feedback data (ratings) and precomputes the weight of the influence or trust of friends on the users based on these ratings.

Before going any further with Collaborative Filtering, some notations have to be introduced. The data from which recommendations can be produced is typically derived from interactions between users iεU and items jεM with a response YᵢⱼεY. The data for n total users interacting with a collection of m items can be thought of as a sparse n×m so-called user-item matrix YεY|U|×|M| where |U| denotes the cardinal of set U.

U={uᵢ}ᵢ₌₁ⁿ represents all the users in a social trust network.

In this context, Yᵢⱼ=1 indicates the existence of an interaction (purchase, rating, etc.) between user i and item j. In this sense, Yᵢⱼ=0 is special, since it does not indicate that a user dislikes an item but rather that data is missing. We thus only have implicit information on which items a user likes. Hence, in order to avoid an estimator that is overly optimistic with regards to user preferences, it is need to take into account unobserved entries (Yᵢⱼ=0) as some form of negative feedback. Moreover, from the social network graph, it is known the set of friends Fᵢ of user i, Fᵢ⊂U.

Some methods leverage the OSN graph information in factor models by adding an additional term to the objective function of the matrix factorization that penalizes the distance

$${\vert {U}_{i} - \frac{1}{\vert {F}_{i} \vert} {\sum }_{k ∈ {F}_{i}} {U}_{k} \vert}^{2}$$

between the factors of friends. This forces profiles among users that are friends to be similar.

In order to learn the characteristics or features of the users, matrix factorization is used to factorize the user-item matrix. The idea of user-item matrix factorization is to derive a high-quality 1-dimensional feature representation U of users and V of items based on analyzing the user-item matrix R. Suppose in a user-item rating matrix, having n users, m items, and rating values within the range [0, 1]. Actually, most recommender systems use integer rating values from 1 to Rmax to represent the users' judgements on items. Without loss of generality, ratings 1, . . . , Rmax can be mapped to the interval [0, 1]. Let Rᵢⱼ represent the rating of user ui for item vⱼ, and UεR^{1×n} and VεR^{1×m} be latent user and item feature matrices, with column vectors Uᵢ and Vⱼ representing the 1-dimensional user-specific and item-specific latent feature vectors of user uᵢ and item vⱼ, respectively.

The basic idea in matrix factorization approaches is to fit the original Y matrix with a low rank approximation F=UM where matrix U contains the user features and V the item features. More specifically, the goal is to find such an approximation that minimizes the sum of the squared distances Σᵢⱼ (Yᵢⱼ−Fᵢⱼ)² between the known entries in Y and their predictions in F.

A class of CF methods often used in recommender systems is memory or similarity based methods that work by computing similarity measures (e.g. Pearson correlation) between users. Another common approach to collaborative filtering and recommendation is to fit a factor model to the data. For example by extracting a feature vector Ui,Vj for each user and item in the data set such that the inner product of these features minimizes an explicit or implicit loss functional following a probabilistic approach). The underlying idea behind these methods is that both user preferences and item properties can be modeled by a number of latent factors.

A refinement to the approach described above that penalizes the distance between the factors of friends proposes, another existing approach proposes that this penalization of the distance between friends is proportional to a Pearson correlation similarity measure

$${\vert {U}_{i} - \frac{{\sum }_{k ∈ {F}_{i}} {sim}_{ik} {U}_{k}}{{\sum }_{k ∈ {F}_{i}} {sim}_{ik}} \vert}^{2}$$

computed on the items the users had consumed. This enforced even greater similarity among friends that have consumed the same items.

Other approaches add the OSN information by minimizing a second binary loss function Σ_{kεF}_{ᵢ}L(Sᵢₖ, UᵢUₖ), where S the adjacency matrix of the graph, in the objective function that penalizes mistakes in predicting friendship. These models also leverage side information (i.e. user, item features) in the model. Another similar method utilizes both a social regularization and a social loss function approach.

On the other hand, in most recommendation domains, the data come in the form of implicit feed-back (purchases, clicks, etc.) in contrast to explicit feedback such as ratings where a user explicitly expresses his positive, neutral or negative attitude towards an item. A key challenge in modeling implicit feedback data is defining negative feedback, since in this case the observed data (user-item interactions) can only be considered as a form of positive feedback. Moreover for non-observed user—item interactions, it cannot be certain if the user did not consider the items or if the user considered the items and simply chose not to interact with the items (reflecting a negative feedback). Hence, these entries cannot be ignored, since this could lead to a model that would be overly optimistic with regard to user preferences.

For example, the matrix factorization approach for implicit feedback data introduced in “Collaborative filtering for implicit feedback datasets” by Hu et al., Proceedings of the IEEE International Conference on Data Mining (ICDM), pp. 263-272. IEEE Computer Society, Washington D.C., 2008, relies on using a least squares loss function and uses a trick that exploits the sparse structure of the data (dominated by non-observed entries) to speed up the optimization process. This approach though does not include any OSN information.

Another existing approach leverages the social network for apps recommendation. There are further approaches that exploit geolocation information and/or user's context to recommend places to user.

For example, WO 2012/126741 introduces a Context-Aware Collaborative Filtering method for implicit data that is based on Tensor Factorization (TF). TF is an N-dimensional extension of Matrix Factorization. However, a straightforward use of this model for implicit data makes it unsuitable for the purpose of CF. In the current section Matrix and Tensor Factorization is introduced and they are explained the details of how these models to use as N-dimensional CF for implicit feedback data have been adapted. The main advantage of using TF is that the same principles that are behind Matrix Factorization in order to deal with N-dimensional information can be applied. Therefore, it provides a way to integrate additional information into the standard user-item matrix.

Another example is the Collaborative recommendation method based on social context described in CN102231166. This method works by imposing a similarity constraint on the friends, that is it, enforces that users become somewhat similar to their friends. The main problem with this approach is that general social networks are very noisy: people build connections/“friendships” with many users with which they have only weak ties and don't share many common interests. By enforcing a similarity constraint with all the users, this method introduces a lot of noise in the modelling process and in the end it works worse than without the social graph data.

In all existing methods the intensity of the social relationship with respect to the preference of the user is not computed in a proper way. Most methods skip these user's preferences, while the ones that do compute some measure do it in an external step, e.g. such as “Learning to recommend with social trust ensemble” by Ma et al. teaches, which does not allow for the computation of this intensity when users do not share items.

### SUMMARY OF THE INVENTION

The current disclosure may solve the aforementioned problems by disclosing a method for multimedia content recommendation based on a Socially Enabled Collaborative Filtering model which directly models the social interactions and quantifies the influence/trust between each one of the users employing the implicit feedback data from the user and his/her friends. The current disclosure may also provide a way to quantify and use this influence in the proposed collaborative filtering model itself, without precomputing any affinity or similarity measures among users. The proposed collaborative filtering model scales linearly to the number of user-item interactions and can be applied on a large-scale industry dataset (e.g., with over 10 millions of users), focusing on the online social network (OSN) integration for place recommendation.

The current disclosure has its application to telecommunication networks, especially to Social networks which provide users with several mechanisms to recommend and rate multimedia contents (e.g., webpages that have “Recommend”, “Share”, “Like”, “Buzz” action buttons for this purpose) to other users of the social network. Thus, the current disclosure allows direct social interaction with existing online communities such as FACEBOOK, MYSPACE, TWITTER, TUENTI, EPINIONS, LINKEDIN, etc.

According to a first aspect, a method for providing multimedia content recommendations is disclosed. The proposed method of content recommendation is based on collaborative filtering, uses implicit user feedbacks and comprises the following steps: retrieving an OSN social graph, which is split into a user i and the user's relationship network; performing collaborative filtering using three factors:
a first factor which is a set of users U of the OSN, the set U containing the user i,
a second factor which is a collection of content items M, and
a third factor A which is a weight parameter indicating an influence of the user's relationship network on the user i;
   modelling interactions between the set of users U and the collection of content items M in the OSN with a user-item matrix Y, wherein a response YᵢⱼεY has a value which is selected from:
a value Yᵢⱼ=1 if there is any interaction between the user iεU and item jεM,
a value Yᵢⱼ=0 if response data between the user i and item j is missed;
   modelling the three factors, U, M and A, by using matrix factorization with an objective function, in order to obtain a social aware model of the user's preferences based on preferences of the users belonging to the user's relationship network; minimizing the objective function for all the response values of the whole user-item matrix Y, the response values meaning implicit and explicit feedback data; providing a list of content recommendations comprising N scores, N≧1, which are the values of a score function Fᵢⱼ, Fᵢⱼ denoting a score of the user iεU on the item jεM, wherein the score function Fᵢⱼ is computed using the social aware model.

In a second aspect, a computer program (which may be stored on a non-transitory memory) is disclosed, comprising computer program code adapted to perform the steps of the described method when said program is run on a computer, a digital signal processor, a field-programmable gate array, an application-specific integrated circuit, a micro-processor, a micro-controller, or any other form of programmable hardware.

The method in accordance with the above described aspects of the disclosure may have a number of advantages with respect to prior art, summarized as follows:

Regarding “Learning to recommend with social trust ensemble” by Ma et al. which naturally fuses the user's tastes and their trusted friend's favors together, a main difference with the present disclosure is the use of implicit data, which is the norm in industry applications, instead of explicit data (ratings) used by Ma et al. Another key difference is that in Ma et al the similarity between two friends has to be precomputed using the overlapping set of rated items, i.e. the weight of the influence or trust of friends on the users are pre-computed based on the items that both friends have rated. This can lead to inaccurate similarity computations, since often there are thousands of items to choose from and users might have chosen similar items but not the same items e.g. two friends watch two lords of the rings movies but one watches the first one and another one watches the third one. By contrast, the current disclosure proposes computing the interaction weights in the model, which allows their computation even when the users do not actually share a common subset of items. The method by Ma et al. does not capture this “similarity”, while the current disclosure does it accurately, since it models the similarity through the collaborative filtering process.

The current disclosure may avoid the introduction of noise in the modelling process by explicitly computing how similar a user is to each of his friends and using only the friends that are similar with the user in terms of preferences. This leads to better performance compared to the method disclosed in CN102231166.

Regarding WO 2012/126741, the method for context-aware recommendations based on implicit user feedback is intended for scenarios where the context of the user is known, e.g. the user is looking for a restaurant on the smartphone and the recommender system is taking into account the location and the weather as the context of the user, to perhaps recommend an outdoors restaurant if the weather is good. In the current disclosure, the users tastes are modelled based on the taste of preferences of the users friends, e.g., if a friend likes a restaurant it might be likely that the user will also like it. In both cases implicit data are used, e.g. it is known that a user is visiting a restaurant, but it is not known the explicit rating of the user for that restaurant, though this type of implicit data is the most common form of data in industry applications.

These and other advantages will be apparent in the light of the detailed description and drawings.

### BRIEF DESCRIPTION OF THE DRAWINGS

For the purpose of aiding the understanding of the characteristics of the current disclosure, according to an exemplary practical embodiment thereof and in order to complement this description, the following figures are attached as an integral part thereof, having an illustrative and non-limiting character:

FIG. 1 shows a flow chart of a method for socially aware content recommendation, in accordance with an exemplary embodiment of the current disclosure;

FIG. 2 presents a graphical representation of the MAP and RANK metric parameters used to evaluate performance of a recommendation method;

FIG. 3 shows a graphical representation of the computational complexity of the method in terms of running-time of the method versus the given ratio of users in the OSN, according to a possible application of the invention;

FIG. 4a shows a graphical representation of the MAP metric parameter obtained for different recommendation methods, included the method of FIG. 1, applied to the Tuenti data, according to a possible application of the invention;

FIG. 4b shows a graphical representation of the RANK metric parameter obtained for different recommendation methods, included the method of FIG. 1, applied to the Tuenti data, according to a possible application of the invention;

FIG. 5a shows a graphical representation of the MAP metric parameter obtained for different recommendation methods, included the method of FIG. 1, applied to the Epinions data, according to another possible application of the invention;

FIG. 5b shows a graphical representation of the RANK metric parameter obtained for different recommendation methods, included the method of FIG. 1, applied to the Epinions data, according to another possible application of the invention;

FIG. 6a shows a graphical representation of the distribution of the influence weighting parameters on the Tuenti data, according to a possible application of the invention; and

FIG. 6b shows a graphical representation of the distribution of the influence weighting parameters on the Epinions data, according to another possible application of the invention.

### DETAILED DESCRIPTION

The matters defined in this detailed description are provided to assist in a comprehensive understanding of the invention(s). Accordingly, those of ordinary skill in the art will recognize that variation changes and modifications of the embodiments described herein can be made without departing from the scope and spirit of the invention(s). Also, description of well-known functions and elements are omitted for clarity and conciseness.

Of course, the embodiments of the invention(s) can be implemented in a variety of architectural platforms, operating and server systems, devices, systems, or applications. Any particular architectural layout or implementation presented herein is provided for purposes of illustration and comprehension only and is not intended to limit aspects of the invention.

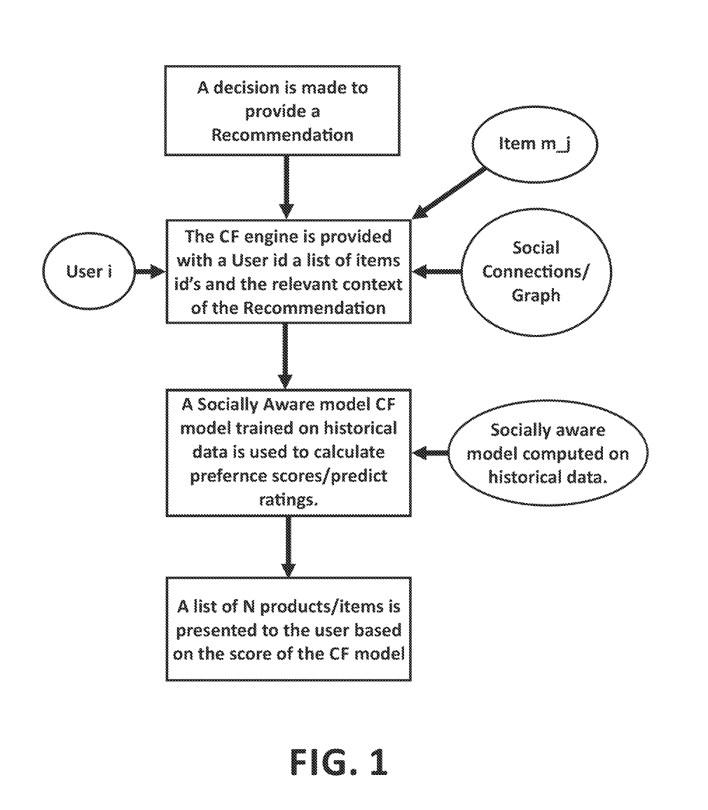

It is within this context, that various embodiments of the invention(s) are now presented with reference to the FIGS. 1-3, 4a-4b, 5a-5b and 6a-6b.

Note that in this text, the term “comprises” and its derivations (such as “comprising”, etc.) should not be understood in an excluding sense, that is, these terms should not be interpreted as excluding the possibility that what is described and defined may include further elements, steps, etc.

FIG. 1 presents a flow chart of the proposed method for content recommendation in an OSN based on a Collaborative Filtering (CF) model which is socially aware. The starting point is deciding to provide recommendation on certain items of multimedia content. These items and the set of users, both items and users identified by respective IDs, are input to a Collaborative Filtering recommender engine. In addition, the CF engine is provided with data on the relevant context of the recommendation, such as the social graph and its connections.

The OSN is modeled as an undirected social graph G=(V,E), where G denotes the social network topology comprising vertices V that represent users at nodes and edges E that represent trust relationships between users. Bilateral social relationships are considered, where each node in V corresponds to a user in the network, and each edge in E corresponds to a bilateral social relationship. Friendship relationship can be represented as an undirected edge E in the graph G. Since social network topologies are relatively static, it is feasible to obtain a global snapshot of the network and, thus, any node of set V knows the complete social graph G. Friendship relationships are already public data for popular social networks, e.g., Facebook or Tuenti. Therefore, the OSN provider has access to the entire social graph G, which is input to the CF engine. Using historical data, a socially aware CF model is computed and trained to calculate preference predictions of the users to score items. Based on the score which results from the socially aware CF model, a list of N ranked items is presented to the user i requesting recommendation.

A factor model of a d dimensional latent user UεR|U|×d and item factors MεRd×|M| is generated so that the scores between a user i and an item j can be used to provide recommendations, typically by displaying the top N scoring items to the user i. The scores are calculated by the inner product between the corresponding rows of the user i and item j latent factor matrices, U and M, i.e., the score of user i on item j is Fᵢⱼ=UᵢMⱼ. The latent factors U and M are typically computed by minimizing some objective functions that either stem from regularized loss functions or are derived from probabilistic models. In both cases, the objectives are of the form:

L(F,Y)+Ω(F) (1)

where L(F, Y) is typically a loss function such as Frobenius norm of the error ∥F−Y∥_{F}² and Ω(F) is a regularization term preventing from overfitting. A typical choice is the Frobenius norm of the factors ∥M∥_{F}²+∥U∥_{F}²

In addition, the proposed method includes the influence of the social graph in a matrix factorization model. In order to model the users preferences, a mixture of his own and those of his friends is chosen. To this end, the score function is changed to include the influence of the friendship network, and thus the score function Fᵢⱼ becomes:

$${F}_{ij} = {U}_{i} {M}_{j} + {\sum }_{k ∈ {F}_{i}} \frac{{α}_{ik}}{\vert {F}_{i} \vert} {U}_{k} {M}_{j} \qquad ( 2 )$$

where αᵢₖ is a weight parameter, whose value is between 0 and 1, which encodes how much friend k influences user i.

As “homophily” is assumed in the social network, it is reasonable to also assume that some of the users' latent preferences might not have been expressed in the user-item data but could instead be encoded in the users friendship network. Moreover, the score function in Equation 2 encodes the fact that the user is “influenced” by his friendship network and the weight αik quantifies the amount of influence each individual friend k has on the user i. OSN users tend to have dozens of friends and the user might be expected to have similar preferences to only a fraction of his friends. Moreover, it must be noted that the influence is not necessarily symmetric as a user might be “influenced” by a friend, but might not be exerting influence on his friend in the same manner.

Given this score function Fij and the objective function in Equation 1, another objective function is computed with respect to the U, M factors and the influence weights αik. We define the matrix A such that Aik=αik,∀i,∀kεFi, 0 otherwise.

$${min}_{U , M , A} J = {\sum }_{( i , j ) ∈ Y} {{c}_{ij} ( {U}_{i} {M}_{j} + {\sum }_{k ∈ {F}_{i}} \frac{{α}_{ik} {U}_{k} {M}_{j}}{\vert {F}_{i} \vert} - {Y}_{ij} )}^{2} + {Ω}_{U , M , A} \qquad ( 3 )$$

where Ω_{U,M,A}=λ₁∥U∥_{F}²+λ₂∥M∥_{F}²+λ₃∥A∥_{F}² is a regularizer term and cij is a constant defined to give more weight to the loss function when dealing with observed entries Yij=1 than when Yij=0.

Although Equation 3 is not jointly convex in U, M, and A, it is still convex in each of this factors whenever the remaining two are kept fixed. Since the proposed method is dealing with implicit feedback data, the same importance cannot be given to information that is known to be true, (i.e. the user clicked/purchased an item represented as a 1 in the Y matrix and thus showed an interest in it), and to information whose real meaning is not known (i.e. the user had no interaction with the item, thus a 0 in the Y matrix and thus there are uncertainty about the potential interest). Note that, in contrast to factor models for explicit data (i.e. ratings) where learning is performed only over the observed ratings, in this case the optimization is performed over the whole matrix Y, including the unobserved entries as a form of weak negative feedback. The objective function in Equation 3 is optimized by using the following block Gauss-Seidel process:
fixing alternatively two of the three parameters (the three factor matrices, U, M or A) and updating a third parameter of them (U, M or A),
when two out of three parameters are fixed, the remaining problem is a basic and convex quadratic least-square minimization that can be efficiently solved.
the optimization process consists in efficiently updating, at each iteration, alternatively the user matrix U, the item matrix M and the weight matrix A.

To get the proper updates for each of the three parameters (Uᵢ, Mⱼ and A=αᵢᵢₖ), the partial derivative of the objective function in equation 3 is calculated according to the corresponding factor matrices, U and M, as follows:

In order to compute the update for the factor vector Ui of a single user i, the derivative of the objective function

$$\frac{\partial J}{\partial {U}_{i}}$$

is calculated with respect to the users factors and set it to 0. We can then analytically solve this expression with respect to Ui. To formulate the update it is convenient to write the equations in a matrix form. To this end, a diagonal matrix CiεR|M|×|M| is defined such that Cⱼⱼⁱ=cᵢⱼ

Cij encodes the confidence in each entry yᵢⱼ in the Y matrix, i.e. observed entries clicks/purchases etc. get high confidence and thus a higher weight cij=1+βyij where e.g. β=20 while when yij=0 i.e. no action has been taken by user i on item j, yij=0 and thus cij=1.

$${U}_{i} = ( {Y}_{i} \cdot {C}^{i} {M}^{T} - \frac{{A}_{i} {UMC}^{i} {M}^{T}}{\vert {F}_{i} \vert} ) {( {MC}^{i} {M}^{T} + {λ}_{1} \vert )}^{- 1} \qquad ( 4 )$$

In this update rule, the real problem is not the inversion of the d×d matrix (which has a complexity of O(d³)), but the computation of MCⁱM^{T} (which seems to be at first glance O(|M|×d²)). Note that MCⁱM^{T} is an operation quadratic in |M| the number of items. Computing this product is too expensive even for the smallest datasets since it has to be done for each user. MCⁱM^{T} can be replaced by MM^{T}+M(Cⁱ−I)M^{T}. Computing MM^{T} is independent of the user i and thus can be calculated once before each iteration (and not for each user i), and by cleverly choosing cij, the product M(Cⁱ−I)M^{T} can be computed efficiently.

Since cij=1+βyᵢⱼ the diagonal terms of Cⁱ−I will be zero for each j where yij=0. We can thus just compute M_{Y}_{ᵢ}(Cⁱ−I)_{Y}_{ᵢ}M_{Y}_{ᵢ}^{T}, where Yᵢ is the set of items of user i. |Yᵢ|<<|M| because matrix Y is by its nature very sparse. This leads to a computational complexity of O(|Yi|×d²) which is linear in the number of items user i had interactions.

In order to update factor matrix M, a matrix U′ defined by

$${Ui}^{′} = Ui {\sum }_{k ∈ {F}_{i}} \frac{{α}_{ik} {U}_{k}}{\vert {F}_{i} \vert} +$$

for each user I, is used. Using U′, the loss function becomes:

$$L ( U , M , A ) = {\sum }_{i , j} {{c}_{ij} ( {U}_{i}^{′} {M}_{j} - {Y}_{ij} )}^{2}$$

The partial derivative calculation is pretty much straightforward and can be easily written in a matrix notation as a diagonal matrix Cj, defined by:

Cⱼⱼⁱ=cᵢⱼ

Note that CjεR|U|×|U| while CiεR|M|×|M|.

The update rule of Mⱼ is as follows:

Mⱼ=(U′^{T}C^{j}U′+λ₂I)⁻¹U′^{T}C^{j}Y.ⱼ (5)

To compute the expensive product, the equation 5 is rewritten using U′^{T}C^{j}U′=U′^{T}U′+U′_{Y}_{ⱼ}^{T}(C^{j}−I)_{Y}_{ⱼ}U′_{Y}_{ⱼ}, where Yj is the set of the users that have purchased/consumed item j. Just like in the process for updating U, U′^{T}U′ is computed once before the iteration over all items. The computational complexity of the update; U′_{Y}_{ⱼ}^{T}(C^{j}−I)_{Y}_{ⱼ}U′_{Y}_{ⱼ} is O(|Yj|×d²).
In order to update factor matrix A, one approach consists in working row by row, i.e. update Ai• for each user i. Since Ai• has the same sparsity structure as the adjacency matrix of the social graph we only need to compute the values A_{iFi}. By using the same procedure as above and setting the partial derivative of the objective to 0, we get:

$${A}_{{iF}_{i}} = ( {Y}_{i} \cdot {C}^{i} {M}^{T} {U}_{{F}_{i}}^{T} - {U}_{i} M {C}^{i} {M}^{T} {U}_{{F}_{i}}^{T} ) {( \frac{{U}_{{F}_{i}} M {C}^{i} {M}^{T} {U}_{{F}_{i}}^{T}}{\vert {F}_{i} \vert} + {λ}_{3} )}^{- 1} \qquad ( 6 )$$

Note again that the computational cost for calculating the product UᵢMCⁱM^{T}U_{F}_{ᵢ}^{T} is limited since we can employ here the same trick we used in the update rules for U and M. The main computational bottleneck is in the computation of the inverse of the matrix which is of size |Fi|×|Fi|, implying a complexity in O(|Fi|³) i.e. the computation scales cubically to the number of friends per user. Depending on the social network, if we have d<<|Fi| for a significant fraction of users, this update rule could be problematic.

Another approach for the update of a, is to compute them not in a user-by-user fashion but relationship-by-relationship, i.e. update αii′ for given user i and friend i′. By calculating the gradient and setting it to zero, we reach the following update rule (equation 7):

$${α}_{ii}^{′} = ( {Y}_{i} \cdot {U}_{i} M - {\sum }_{k ∈ {F}_{i} k \neq {i}^{′}} \frac{{α}_{ik} {U}_{k} M}{\vert {F}_{i} \vert} ) {C}^{i} {M}^{T} {{U}_{{i}^{′}}^{T} ( \frac{{U}_{i}^{′} M {C}^{i} {M}^{T} {U}_{{i}^{′}}^{T}}{\vert {F}_{i} \vert} + {λ}_{3} )}^{- 1} \qquad ( 7 )$$

In this case, we just have to invert a scalar. And we can use the same trick as in the update of U to compute the product MCⁱM^{T}. This can indeed be rewritten as MCⁱM^{T}=MM^{T}+M_{Y}_{ᵢ}(Cⁱ−I)_{Y}_{ᵢ}M_{Y}_{ᵢ}^{T}, where Yi is the set of the items liked/purchased by the user i. Given that the complexity of computing Equation 7 is linear to the number of friends of i, while the complexity of Equation 6 is polynomial to the number of friends of i we choose to use Equation 7. Finally note that a parameter provides a relative measure of the influence (or trust) of a given user on his friends.

Given the above described optimization procedures for U, M and A, each of these factor matrices are iteratively updated by always keeping the other two factor matrices fixed and this procedure is repeated until convergence.

Using Equation 2 at prediction time can be slow, since it requires extensive memory access due to the need to retrieve the friends from the social graph. To speed up the computation of the scores at prediction time, the following mixed user factors are precomputed as:

$${U}_{i}^{′} = {U}_{i} + {\sum }_{k ∈ {F}_{i}} \frac{{α}_{ik}}{\vert {F}_{i} \vert} {U}_{k} .$$

Finally, the score computation then becomes:

Fᵢⱼ=U′ᵢMⱼ.

The proposed collaborative filtering model scales linearly to the number of user-item interactions and has been tested on a large-scale industry dataset (e.g., with over 10 millions of users), where it outperforms state-of-the-art socially enabled collaborative filtering methods. More particularly, the model has been extensively tested on two datasets, Tuenti and Epinions, and been compared to three state-of-the-art socially-enabled collaborative filtering methods and a matrix factorization method.

In the following experiment, data from the places service of the Tuenti OSN have been used. Tuenti is Spain's leading OSN in terms of traffic. Over 80% of Spaniards aged 14-27 actively use the service and today counts more than 14M users and over a billion daily page views. Early 2010, a feature was added to the Tuenti web platform whereby users could tell their friends where they were, and which places they particularly enjoyed. These places where added to the user's profile. The Tuenti place-user interaction matrix, as the matrix Y, has been used. Y contains all the places the users have added to their profile. Also the social network F as the friendship matrix of Tuenti users has been used. The data contains about 10 million users and approximately 100,000 places. Both of the matrices are very sparse, as each user has on average 4 places in his profile and 60 friends. The social graph among the Tuenti users contains approximately 700 Million of edges nodes that is each user has on average 70 friends. Note that this is an industry-scale dataset where the user/places graph takes up 2 GB of storage space and the social graph data 22 GB.

On the other hand, the Epinions data contains about 50 k (50 thousand) users and approximately 140,000 articles. Here users form a social graph (500 k edges) based on the trust they show on each other's reviews/ratings. Unlike the Tuenti data, the Epinions data is in the form of ratings with values between 1 and 5. The rating values are replaced by 1 to convert the data to implicit feedback.

In contrast to the Tuenti data, the relationships of the users are much better defined in the Epinions data in that they reflect trust in another users' opinion. Social relationships as the ones in the Tuenti data capture a much wider range of relationships between users, e.g. family relationships, neighbors, classmates etc. which might not always translate into trust/influence.

TABLE 1
Summary of the data used for the experiments

| Users | | Places/Items | Edges in SN |
|---|---|---|---|
| Tuenti | 10M | 100K | 700M |
| Epinions | 50K | 140K | 500K |

For the evaluation procedure, the dataset has been split into two parts, a training set to learn our model and a test set for evaluation. The test set contains the last 25% of places or items added to each user's profile, and the training set contains all the remaining places/items that were added in the user's profile. For each user, some unobserved entries Yij=0 are drawn randomly assuming that these places/items are irrelevant to the user. These randomly chosen unobserved entries have been used for training some of the methods in comparison for both datasets. The CF model has been trained to compute a score Fij for each user i and place j in the test set along with the randomly drawn irrelevant items, and the items are ranked for each user according to their scores. In recommendation algorithms, we ultimately care about the ranking of the items, we thus use ranking metrics for the evaluation. A popular list-wise ranking measure for this type of data is the Mean Average Precision metric (MAP) which is particularly well suited to recommendations ranking since it puts an emphasis in getting the first items in the ranked list right. MAP can be written as in equation 8:

$$MAP = \frac{1}{\vert U \vert} {\sum }_{i = 1}^{\vert U \vert} \frac{{\sum }_{k = 1}^{\vert M \vert} P ( k ) {Y}_{ik}}{\vert {Y}_{i} \vert} \qquad ( 8 )$$

where P(k) is the precision at the cut-off k.

In order to evaluate the performance of the different models a RANK metric is computed as in equation 9:

$$RANK = \frac{{\sum }_{i , j} {Y}_{ij} {rank}_{ij}}{\vert Y \vert} \qquad ( 9 )$$

where rankᵢⱼ is the percentile-ranking of the item j for a given user i.

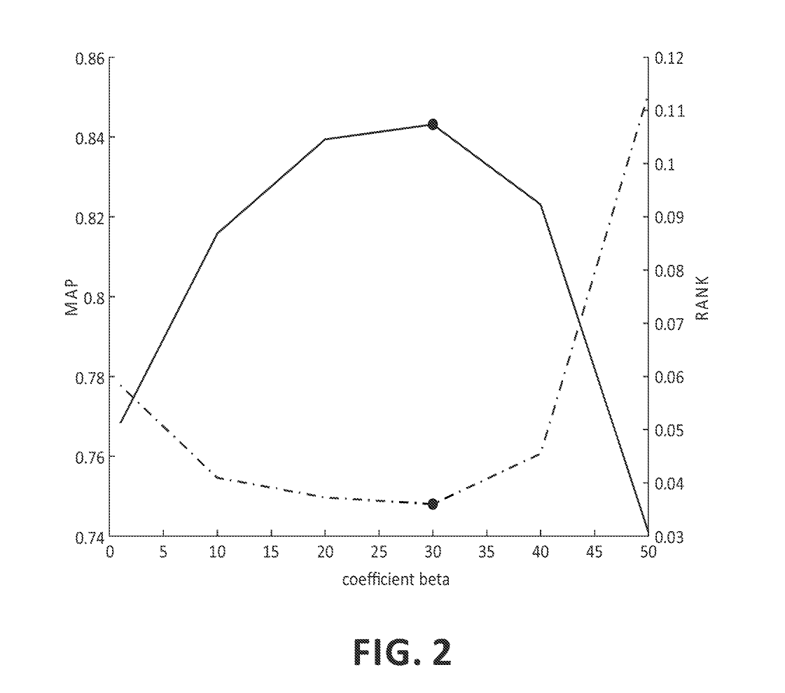

FIG. 2 shows the MAP and RANK metrics with respect to the value of coefficient beta (β). In contrast to the MAP metric, in RANK metric smaller values indicate better performance.

The first method we compare against is a matrix factorization method based on alternating least squares optimization described in “Collaborative filtering for implicit feedback datasets” by Hu et al. This method (denoted here as iMF) is tailored to implicit feedback data, but does not take the social graph into account. We can gauge based on the comparison with this method how much the use of the social data improves the recommendation performance.

The second method we compare against is “Like like alike: joint friendship and interest propagation in social networks” by Yang et al., Proceedings of the 20th International Conference on World Wide Web, WWW 2011, pp. 537-546. ACM, New York, 2011. This method (denoted here as LLA) takes advantage of the social graph along with contextual information to perform their recommendation. The resulting model is used to predict both items and friends for a given user. As the focus here is on the social aspect we do not use any contextual information but only the social graph. Thus adapting their objective function to the experimental evaluation environment comprises optimizing equation 10:

$${min}_{U , M} {\sum }_{( i , j ) ∈ y} L ( {U}_{i} {M}_{j} , {Y}_{ij} ) + {\sum }_{i , {i}^{′} ∈ {ℱ}_{i}} L ( {U}_{i} {U}_{{i}^{′}}^{T} , {S}_{ij} ) + {Ω}_{U , M} \qquad ( 10 )$$

where S represents the social graph (in which Sii′ is 1 if the users i and i′ are friends, 0 otherwise), and where L and Ω are respectively the loss function and the regularizer. The method was tested with several different loss function, we picked the one that gave the best results, the logistic loss function and used a simple 12-norm for the regularization term. Following Yang et al., a stochastic gradient descent algorithm was used to optimize this objective.

The third method we compare against was introduced in “Recommender systems with social regularization” by Ma et al., Proceedings of the Fourth ACM International Conference on Web Search and Data Mining, WSDM 2011, pp. 287-296. ACM, New York, 2011. This method (denoted here as RSR) takes the social data into account by penalizing the 12 distance between friends in the objective function. Two ways are proposed to penalize the distance between friends: we choose the one that gave them the best performance, i.e. the one denoted individual-based regularization. The objective function minimized is in this case the following:

$${min}_{U , M} {\sum }_{( i , j ) ∈ y} {( {U}_{i} {M}_{j} - {Y}_{ij} )}^{2} + {\sum }_{i , {i}^{′} ∈ , {ℱ}_{i}} sim ( i , {i}^{′} ) {‖ {U}_{i} - {U}_{{i}^{′}} ‖}_{F}^{2} + {λ}_{1} {‖ U ‖}^{2} + {λ}_{2} {‖ M ‖}^{2}$$

where sim(i,i′) is a similarity score between a user i and a user i′. This similarity can be computed using vector space similarity or a Pearson correlation coefficient. Also here a stochastic gradient descent algorithm is used to optimize the objective function.

The last method we compare against is the one described in “Learning to recommend with social trust ensemble” by Ma et al., Proceedings of the 32nd International ACM SIGIR Conference on Research and Development in Information Retrieval, SIGIR 2009, pp. 203-210. ACM, New York, 2009. This method (denoted here as Trust Ensemble) handles explicit feedback (ratings) and the social trust matrix A is precomputed. The model is then trained by optimizing a simple loss among the factors U and V, using a user-item rating dataset. We fit their method to the implicit feedback problem by, precomputing and fixing the matrix A at the beginning, and using the ponderation trick on the objective (with the use of the coefficients cij) to make implicit feedback learning possible.

The current disclosure is also compared to a baseline: the average predictor, which will recommend the overall most popular places to each user.

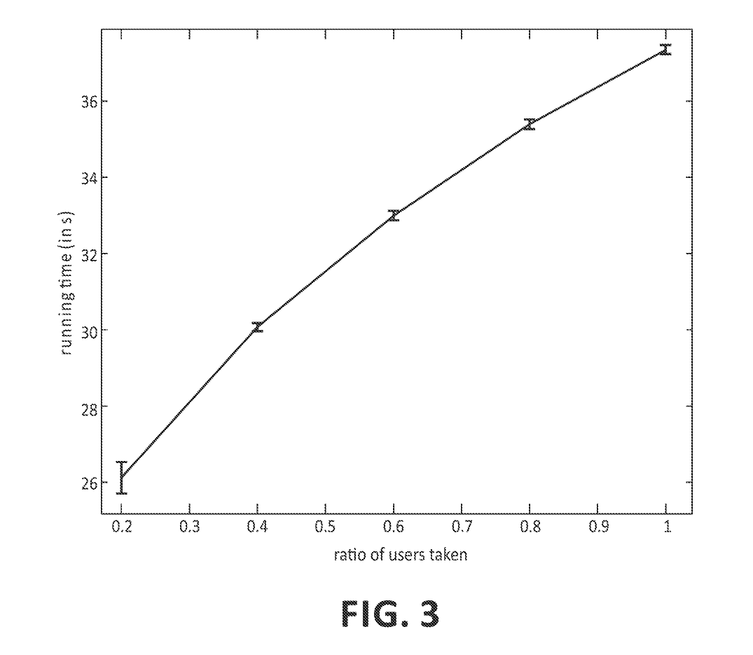

Firstly, in order to validate the efficiency of the current disclosure, the time needed to execute one iteration of the proposed method is measured by using a varying portion of the training data. The proposed method is expected to show linear scalability in terms of the users and the observed entries in the user/item dataset. To this end the Epinions data are used and one iteration of the algorithm runs for each random data split. Those tests have been performed using a single Intel i5 core. The resulting timing information is displayed in FIG. 3. Note the linear growth in the running-time of the method given the different data splits. The running time of one iteration by the proposed method gives different random data splits 20%, 40%, etc., over the Epinions data.

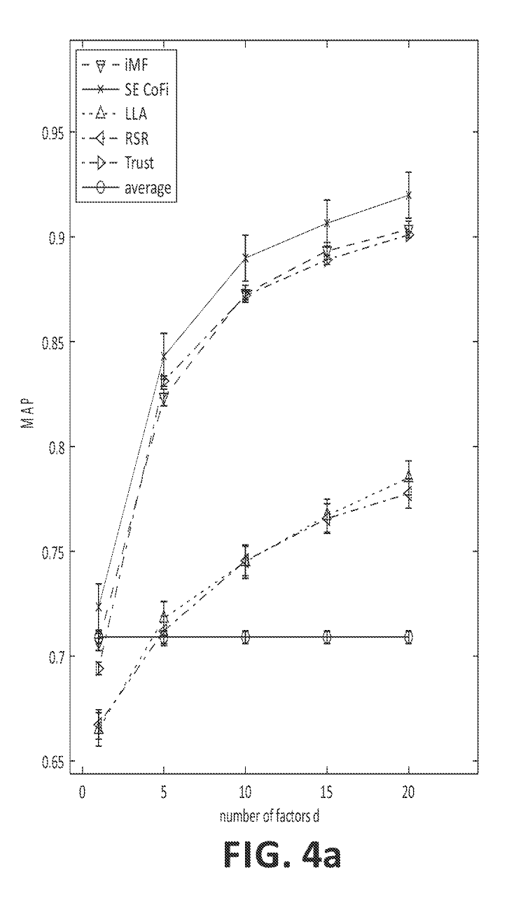

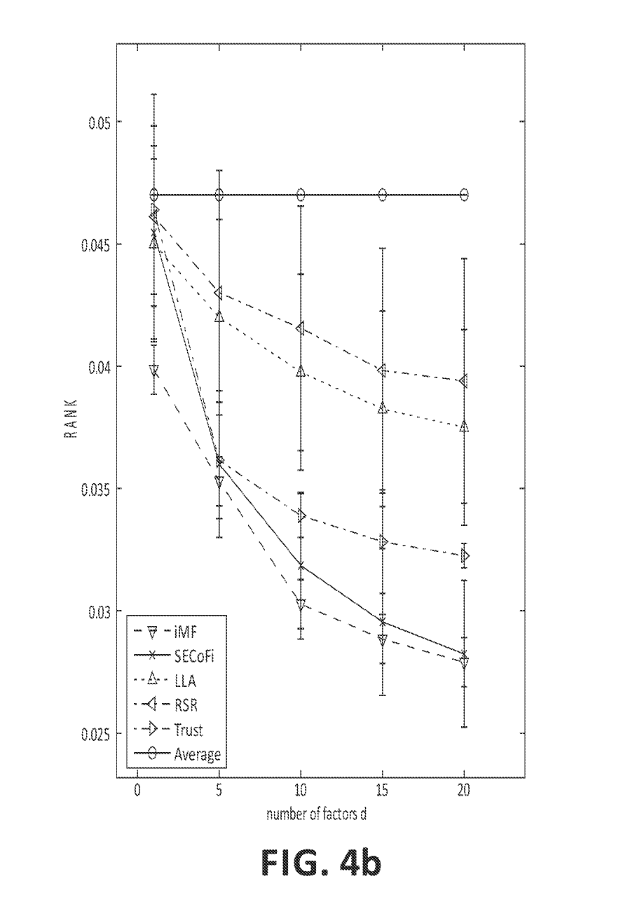

FIGS. 4a-4b show the results in the case that the aforementioned methods are applied to the Tuenti dataset in accordance with a possible application of the invention. Cross-validation has been performed for model selection. The factor matrices U and M were randomly initialized drawing from a uniform distribution between 0 and 1. For the initialization of the friendship weight αᵢⱼ, we found out empirically that the best performance is achieved by initializing with αᵢⱼ=1. We also estimate that the optimal value of the parameter (used in the coefficient cᵢⱼ) is β=30, according to the MAP and the RANK metrics shown in FIG. 2. We used this value of β for all the experiments. The performance of the current disclosure was validated also over a range of values of the number d of factor parameters (1, 5, 10, 15 and 20) on Tuenti. The experiments were repeated several (10) times for each method and report the mean values of the runs along with the standard deviations, running experiments for different values of the number d for each method: i) iMF, ii) LLA, iii) RSR, iv) Trust Ensemble, v) Average Predictor and the method proposed here (denoted as SECoFi: Socially Enabled Collaborative Filtering). FIGS. 4a and 4b illustrate that, even for a small number of factors, SECoFi outperforms the alternative social LLA and RSR enabled methods both in terms of MAP and RANK (over 17% improvement for the MAP and over 14% for the RANK). Moreover, SECoFi is significantly better than iMF in terms of MAP, and for higher values of d our method becomes statistically equivalent to iMF in terms of RANK. Note that for recommendations where only a small number of items k is shown to the user, the importance of MAP is bigger than RANK since MAP is a top-biased evaluation measure, i.e. placing items at the top of the list is more important than lowering the overall ranking of the all the items. SECoFi clearly outperforms in terms of MAP and RANK the Trust Ensemble method. Surprisingly iMF seems to outperform the alternative socially-enabled LLA and RSR methods in the comparison. One of the reasons for this might be the strong sparsity of the data, which bodes well with methods that take all the non-observed entries into account. The relative performance between the methods does not depend strongly on the number of latent variables used. Except for Trust Ensemble method, which was statistically equivalent to our method for small dimension, but we clearly see the difference for bigger dimensions. Indeed, SECoFi outperforms Trust Ensemble as well in terms of MAP as of RANK for a number of factors d≧10. SECoFi outperforms the other methods for all the values of d we tested with. We thus confirm that the relative performance of the current disclosure (SECoFi) does not depend on the number d of factors for most of the alternative methods; we also observe that the relative performance SECoFi method with regards to Trust Ensemble is enhanced with higher numbers of factors. We also observe that the optimal regularization parameters for SECoFi were always the same, independent of the value of d. This eases the model selection process particularly compared to SGD based methods where both a learning rate and a regularizer need to be tuned. Moreover, it seems that the methods based on alternated least-square (ALS) optimization perform better predictions than those that use SGD. Note that the SGD-based methods subsample the unobserved entries to avoid biasing the estimator.

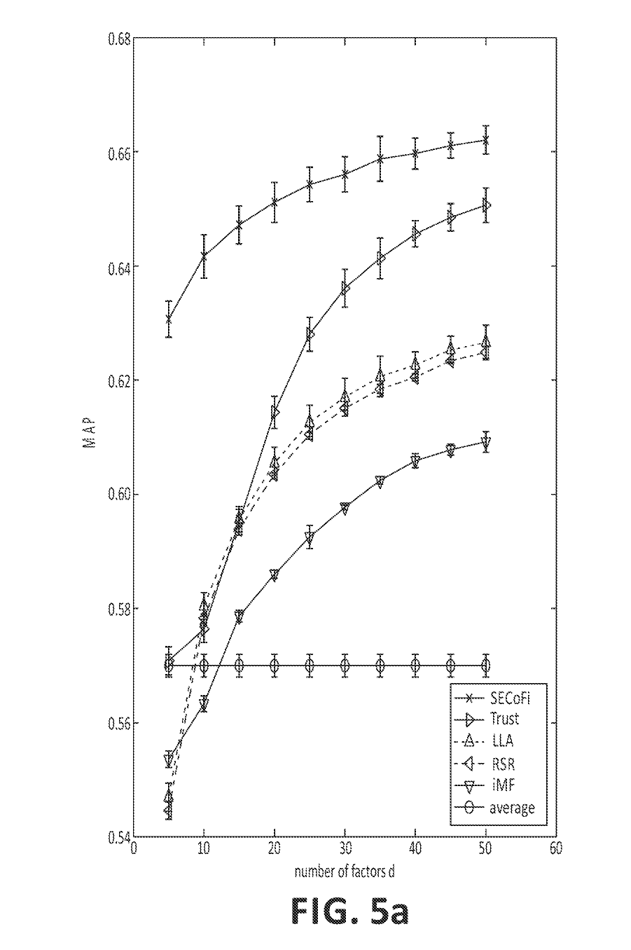

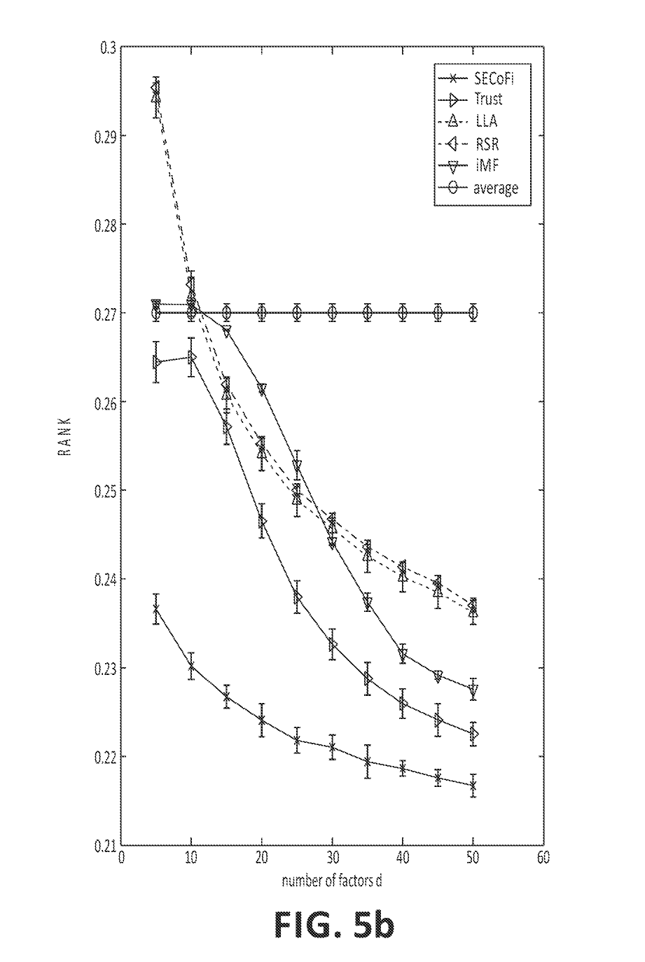

FIGS. 5a-5b show the results in the case that the aforementioned methods are applied to the Epinions dataset in accordance with another possible application of the invention. The experimental evaluation of SECoFi was repeated on the publicly available Epinions dataset (http://snap.stanford.edu/data/soc-Epinions1.html). The same procedure as described for the Tuenti data was followed and the experiment results for the different methods on the Epinions data in terms of MAP and RANK metrics are shown in FIGS. 5a and 5b respectively. From the results similar conclusions to the experiments with the Tuenti data can be drawn: learning the friendship weights matrix A during the optimization process significantly improves the performance over methods that just use the social network information as proposed by Ma et al in “Learning to recommend with social trust ensemble without quantifying these relationships”. Note that SECoFi outperforms the second best method Trust Ensemble by 2.4% in terms of MAP and by 4.1% in terms of RANK, while SECoFi outperforms the remaining methods in comparison by more than 6% both in terms of MAP and RANK. We observe that ALS based methods that take all the “unobserved entries” of the data into account perform better then SGD-based approaches that sample the space of “unobserved entries”. Moreover, SECoFi performs relatively well even utilizing a smaller numbers of factors d. This can be particularly useful in recommendation engines that need to be compact in terms of memory usage, e.g. on a smartphone.

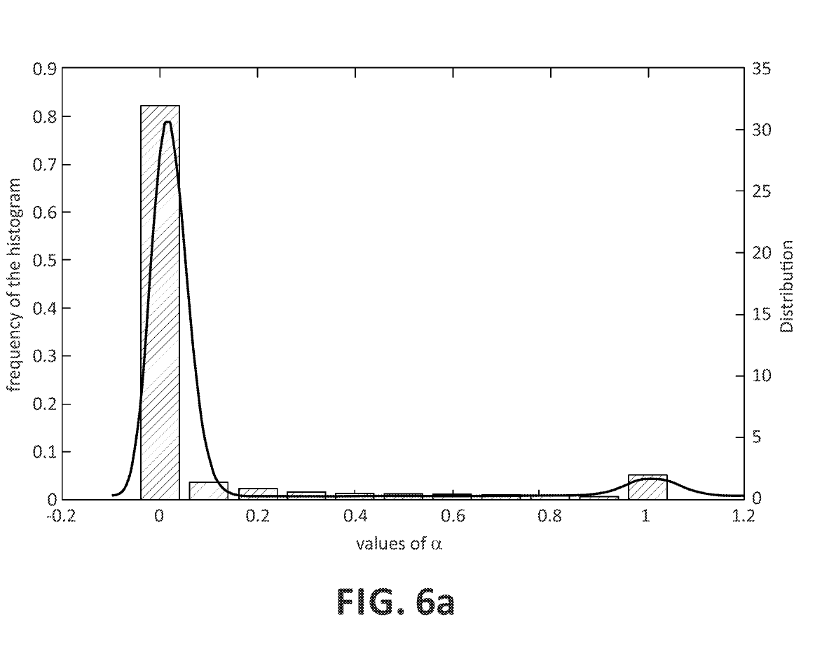

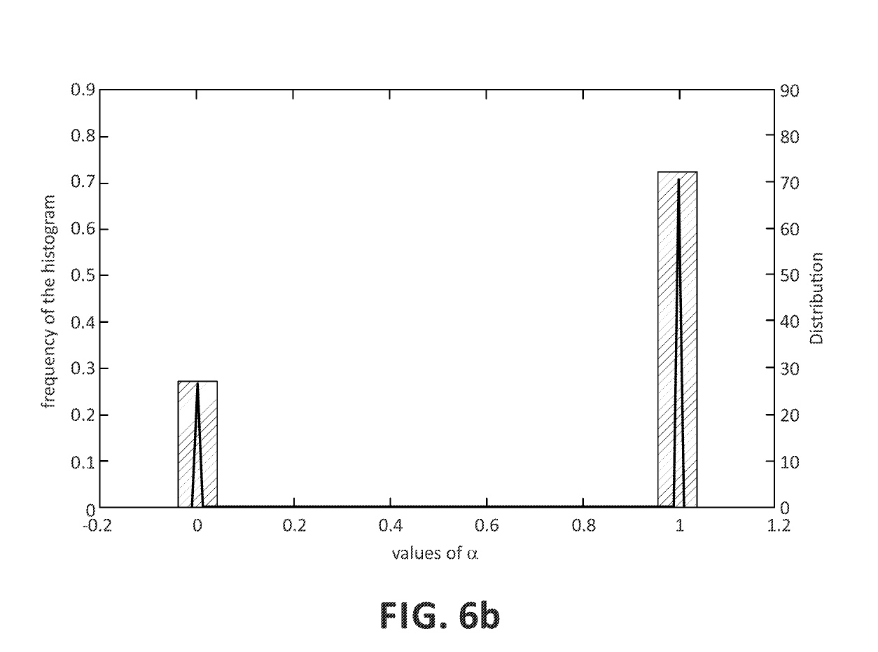

FIGS. 6a and 6b are two histograms, FIG. 6a regarding the described experiments with the Tuenti dataset and FIG. 6b regarding the same experiments with the Epinions dataset, plotting the distribution of the values of α for these two datasets. Recall that the values of α encode the degree of influence or trust among users. We observe that for both of the datasets there is a bimodal distribution. For the Epinions dataset, most of the α values are between 0 and 1 (99%) and 70% of the values are around 1, signaling strong trust relationships among users. For Tuenti, fewer values of α are around 1, and most of the values are close to 0. While there is still some significant influence/trust among users it is less prevalent than in the Epinions dataset. This reflects the nature of the data: in the Epinions dataset the social network of the users is based on the trust that the users put on each other's opinions/ratings while the social relationships on the Tuenti network are of much broader scope and can range from close friendships to simple acquaintances, thus we also expect that a smaller fraction of these relationships will reflect trust/influence. Note also that SECoFi outperforms the competing methods to a higher degree on the Epinions data, another indication that the social information in this dataset provides more information on the preferences of the users. Another important point is that SECoFi depends less on the “quality” of the users Social Network. In fact, the iMF method, which does not utilize OSN information, is the best runner up in the experiments on the Tuenti dataset. This can be attributed to the more relaxed definition of friends in a general purpose social network such as Tuenti, where we can expect that not all friends share the same taste and preferences with the user. Alternative approaches relying on a non-adaptive contribution of friends (RSR, LLA) suffer more in this context, while learning the weights α helps SECoFI to keep only the useful part of the social network users with respect to the recommendations.

To provide additional context for various aspects of the current disclosure, the following discussion is intended to provide a brief, general description of a suitable computing environment in which the various aspects of the current disclosure may be implemented. While example embodiments of the current disclosure relate to the general context of computer-executable instructions that may run on one or more computers, those skilled in the art will recognize that the embodiments also may be implemented in combination with other program modules and/or as a combination of hardware and software.

Generally, program modules include routines, programs, components, data structures, etc., that perform particular tasks or implement particular abstract data types. Moreover, those skilled in the art will appreciate that aspects of the inventive methods may be practiced with other computer system configurations, including single-processor or multiprocessor computer systems, minicomputers, mainframe computers, as well as personal computers, hand-held wireless computing devices, microprocessor-based or programmable consumer electronics, and the like, each of which can be operatively coupled to one or more associated devices. Aspects of the current disclosure may also be practiced in distributed computing environments where certain tasks are performed by remote processing devices that are linked through a communications network. In a distributed computing environment, program modules may be located in both local and remote memory storage devices.

A computer may include a variety of computer readable media. Computer readable media may be any available media that can be accessed by the computer and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media (i.e., non-transitory computer readable media) includes, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which may be used to store the desired information and which may be accessed by the computer.

An exemplary environment for implementing various aspects of the current disclosure may include a computer that includes a processing unit, a system memory and a system bus. The system bus couples system components including, but not limited to, the system memory to the processing unit. The processing unit may be any of various commercially available processors. Dual microprocessors and other multi-processor architectures may also be employed as the processing unit.

The system bus may be any of several types of bus structure that may further interconnect to a memory bus (with or without a memory controller), a peripheral bus, and a local bus using any of a variety of commercially available bus architectures. The system memory may include read only memory (ROM) and/or random access memory (RAM). A basic input/output system (BIOS) is stored in a non-volatile memory such as ROM, EPROM, EEPROM, which BIOS contains the basic routines that help to transfer information between elements within the computer, such as during start-up. The RAM may also include a high-speed RAM such as static RAM for caching data.

The computer may further include an internal hard disk drive (HDD) (e.g., EIDE, SATA), which internal hard disk drive may also be configured for external use in a suitable chassis, a magnetic floppy disk drive (FDD), (e.g., to read from or write to a removable diskette) and an optical disk drive, (e.g., reading a CD-ROM disk or, to read from or write to other high capacity optical media such as the DVD). The hard disk drive, magnetic disk drive and optical disk drive may be connected to the system bus by a hard disk drive interface, a magnetic disk drive interface and an optical drive interface, respectively. The interface for external drive implementations includes at least one or both of Universal Serial Bus (USB) and IEEE 1394 interface technologies.

The drives and their associated computer-readable media may provide nonvolatile storage of data, data structures, computer-executable instructions, and so forth. For the computer, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the current disclosure.

A number of program modules may be stored in the drives and RAM, including an operating system, one or more application programs, other program modules and program data. All or portions of the operating system, applications, modules, and/or data may also be cached in the RAM. It is appreciated that the invention may be implemented with various commercially available operating systems or combinations of operating systems.

It is within the scope of the disclosure that a user may enter commands and information into the computer through one or more wired/wireless input devices, for example, a touch screen display, a keyboard and/or a pointing device, such as a mouse. Other input devices may include a microphone (functioning in association with appropriate language processing/recognition software as known to those of ordinary skill in the technology), an IR remote control, a joystick, a game pad, a stylus pen, or the like. These and other input devices are often connected to the processing unit through an input device interface that is coupled to the system bus, but may be connected by other interfaces, such as a parallel port, an IEEE 1394 serial port, a game port, a USB port, an IR interface, etc.

A display monitor or other type of display device may also be connected to the system bus via an interface, such as a video adapter. In addition to the monitor, a computer may include other peripheral output devices, such as speakers, printers, etc.

The computer may operate in a networked environment using logical connections via wired and/or wireless communications or data links to one or more remote computers. The remote computer(s) may be a workstation, a server computer, a router, a personal computer, a portable computer, a personal digital assistant, a cellular device, a microprocessor-based entertainment appliance, a peer device or other common network node, and may include many or all of the elements described relative to the computer. The logical connections or data links could include wired/wireless connectivity to a local area network (LAN) and/or larger networks, for example, a wide area network (WAN). Such LAN and WAN networking environments are commonplace in offices, and companies, and facilitate enterprise-wide computer networks, such as intranets, all of which may connect to a global communications network such as the Internet. For the purposes of the current disclosure a data link between two components may be any wired or wireless mechanism, medium, system and/or protocol between the two components, whether direct or indirect, that allows the two components to send and/or received data with each other.

The computer may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (such as IEEE 802.11x (a, b, g, n, etc.)) and Bluetooth™ wireless technologies. Thus, the communication may be a predefined structure as with a conventional network or simply an ad hoc communication between at least two devices.

The system may also include one or more server(s). The server(s) may also be hardware and/or software (e.g., threads, processes, computing devices). The servers may house threads to perform transformations by employing aspects of the invention, for example. One possible communication between a client and a server may be in the form of a data packet adapted to be transmitted between two or more computer processes. The data packet may include a cookie and/or associated contextual information, for example. The system may include a communication framework (e.g., a global communication network such as the Internet) that may be employed to facilitate communications between the client(s) and the server(s).

Following from the above description summaries, it should be apparent to those of ordinary skill in the art that, while the methods, apparatuses and data structures herein described constitute exemplary embodiments of the current disclosure, it is to be understood that the inventions contained herein are not limited to the above precise embodiments and that changes may be made without departing from the scope of the invention as claimed. Likewise it is to be understood that it is not necessary to meet any or all of the identified advantages or objects of the invention disclosed herein in order to fall within the scope of the inventions, since inherent and/or unforeseen advantages of the current disclosed embodiments may exist even though they may not have been explicitly discussed herein.

What is claimed is:

1. One or more non-transitory memory components containing computer instructions for instructing a computer system to perform the steps of:
retrieving a social graph of an online social network, split into a user i and the user's relationship network;
performing collaborative filtering using a first factor which is a set of users U of the online social network containing the user i and a second factor which is a collection of content items M;
modelling interactions between the set of users U and the collection of content items M in the online social network with a user-item matrix Y, wherein a response YᵢⱼεY has either a value Yᵢⱼ=1 if there is interaction between the user iεU and item jεM or a value Yij=0 if response data between the user i and item j is missed,
wherein performing collaborative filtering further comprises using a third factor A which is a weight parameter indicating an influence of the user's relationship network on the user i;
modelling the three factors, U, M and A, by using matrix factorization with an objective function, in order to obtain a social aware model of the user's preferences based on preferences of the users belonging to the user's relationship network;
minimizing the objective function for all the response values of the whole user-item matrix Y, the response values meaning implicit and explicit feedback data; and
providing a list of content recommendations comprising N scores, N≧1, which are the values of a score function Fᵢⱼ, Fᵢⱼ denoting a score of the user iεU on the item jεM, wherein the score function Fᵢⱼ is computed using the social aware model.

2. The one or more non-transitory memory components of claim 1, wherein implicit feedback data are selected from a list comprising a click on an item, mouse movements, a purchase, installation of an application, browsing history, usage history, search patterns, and wherein explicit feedback data are ratings which explicitly express positive, neutral or negative attitude of the user iεU and the user's relationship network towards an item jεM.

3. The one or more non-transitory memory components of claim 1, wherein the score function Fᵢⱼ is computed as Fᵢⱼ=U′ᵢMⱼ. where
$${U}_{i}^{′} = {U}_{i} + {\sum }_{k ∈ {F}_{i}} \frac{{a}_{ik}}{\vert {F}_{i} \vert} {U}_{k}$$
being
Fᵢ, a set of the users belonging to the relationship network of user I;
αᵢₖ, a weight parameter value of the third factor A, indicating the influence of the user k on the user i, the third factor A being defined as a matrix A such that Aik=αᵢₖ,∀i,∀kεFi, 0 otherwise;
Mⱼ defines the item jεM,
Uᵢ defines the user iεU,
Uₖ defines the user kεFᵢ.

4. The one or more non-transitory memory components of claim 1, wherein minimizing the objective function comprises:
fixing alternatively two of the three factors selected from the first factor U, the second factor M and the third factor A, and updating a remaining one selected from the three factors U, M and A;
updating iteratively, and alternatively at each iteration, the first factor U, the second factor M and the third factor A;
repeating the fixing and updating steps until convergence.

5. The one or more non-transitory memory components of claim 4, wherein updating any of the three factors U, M and A comprises performing a convex quadratic least-square minimization.

6. The one or more non-transitory memory components of claim 1, wherein minimizing the objective function comprises computing:
$${min}_{U , M , A} J = {\sum }_{( i , j ) ∈ y} {{c}_{ij} ( {U}_{i} {M}_{i} + {\sum }_{k ∈ {F}_{i}} \frac{{a}_{ik} {U}_{k} {M}_{j}}{\vert {F}_{i} \vert} - {Y}_{ij} )}^{2} + {Ω}_{U , M , A}$$
where Ω_{U,M,A}=λ₁∥U∥_{F}²+λ₂∥M∥_{F}²+λ₃∥A∥_{F}² is a regularizer term and cᵢⱼ is a constant which indicates a weight confidence in the response YᵢⱼεY, cij having a higher value when the response is Yᵢⱼ=1 than when Yᵢⱼ=0.

7. The one or more non-transitory memory components of claim 6, wherein updating any of the three factors U, M and A comprises performing the partial derivative of the objective function.

8. A computerized system for providing content recommendations based on collaborative filtering using implicit user feedback, comprising:
a computer readable medium programmed with instructions to perform the steps of:
retrieving a social graph of an online social network, split into a user i and the user's relationship network;
performing collaborative filtering using a first factor which is a set of users U of the online social network containing the user i and a second factor which is a collection of content items M;
modelling interactions between the set of users U and the collection of content items M in the online social network with a user-item matrix Y, wherein a response YijεY has either a value Yij=1 if there is interaction between the user iεU and item jεM or a value Yij=0 if response data between the user i and item j is missed,
wherein performing collaborative filtering further comprises using a third factor A which is a weight parameter indicating an influence of the user's relationship network on the user i;
modelling the three factors, U, M and A, by using matrix factorization with an objective function, in order to obtain a social aware model of the user's preferences based on preferences of the users belonging to the user's relationship network;
minimizing the objective function for all the response values of the whole user-item matrix Y, the response values meaning implicit and explicit feedback data; and
providing a list of content recommendations comprising N scores, N≧1, which are the values of a score function Fᵢⱼ, Fᵢⱼ denoting a score of the user iεU on the item jεM, wherein the score function Fᵢⱼ is computed using the social aware model.

9. The computerized system of claim 8, further comprising a distributed network of computers.
